(19) United States
(12) Patent Application Publication
(10) Pub. No.: US 2026/0177982 A1
(43) Pub. Date: Jun. 25, 2026

(54) WATCH AND METHOD FOR FASTENING THE DIAL TO THE WATCH PLATE

(71) Applicant: ETA SA Manufacture Horlogere Suisse, Grenchen (CH)

(72) Inventors: Gautier SCHNEIDER, Neuchâtel (CH); Christian RUFENACHT, Bienne (CH)

(73) Assignee: ETA SA Manufacture Horlogere Suisse, Grenchen (CH)

(21) Appl. No.: 19/413,211

(22) Filed: Dec. 9, 2025

(30) Foreign Application Priority Data
Dec. 19, 2024 (EP) 24221431.0

(51) Int. Cl. G04B 19/14

(52) U.S. Cl. CPC G04B 19/14

(57) ABSTRACT

A watch including a movement including a plate. The dial (2) of the watch is attached to the plate. The dial includes dial feet (3) fastened to the rear face of the dial (2). The feet are inserted into orifices (4) that run through the plate from its front face (5) to its rear face (6). The orifices (4) includes a peripheral stop (7) so that the ends (11) of the feet move away from the stop (7). Fastening elements (13) are fitted to the feet (3) on the side with the ends, with the addition of axial damping elements (14) arranged between the fastening elements (13) and the stops (7) on the orifices (4). The damping elements (14) are produced using a flexible material and partially compressed between the fastening elements (13) and the stops (7), to dampen the effects of frontal shocks on the plate and dial.

### CROSS-REFERENCE TO RELATED APPLICATIONS

This application claims priority to European Patent Application No. 24221431.0, filed on Dec. 19, 2024, the entire contents of which are incorporated herein by reference.

### TECHNICAL FIELD

The invention relates to the field of horology. The invention relates in particular to the fastening of the watch dial to the plate on the watch movement.

### Technological background

In the horology industry, the dial is often fastened by bolts or keys that attach the dial to the plate on the watch movement. The rigidity of fastening systems of this type makes the dial sensitive to deterioration caused by shocks. Almost all of the energy, especially from frontal shocks, is transmitted to the dial, which can crack.

It would therefore be desirable to have a solution that better protects the dial from shocks to the watch.

### SUMMARY OF THE INVENTION

The invention aims to provide a solution to the problems described above. This objective is achieved by a watch and by the methods according to the claims appended hereto.

A watch according to the invention comprises a movement comprising a plate. The watch dial is attached to the plate. The dial comprises dial feet fastened to the rear face of the dial. The feet are inserted into orifices that run through the plate from its front face to its rear face. The orifices comprise a peripheral stop, preferably set back from the rear face of the plate, such that the ends of the feet extend away from said stop. Fastening elements, such as nuts, are fitted to the feet on the side with said ends, with the addition of axial damping elements arranged between the fastening elements and the orifice stops. The damping elements are produced using a flexible material and these elements are partially compressed between the fastening elements and said stops, so as to dampen the effects of frontal shocks on the entire plate and dial.

According to specific embodiments, the watch also comprises lateral damping elements arranged between the dial feet and the wall of the orifices, so as to also reduce the effect of lateral shocks.

### BRIEF DESCRIPTION OF THE FIGURES

The invention will be described in greater detail below with reference to the appended drawings, which are given by way of non-limiting examples, in which:

FIG. 1 shows a view of the rear face of the watch plate according to the invention, with the watch dial attached to the front face of the plate;

FIG. 2 is a cross-sectional view of the assembly shown in FIG. 1;

FIG. 3 is a close-up of the cross-sectional view shown in FIG. 2, to illustrate the position of one of the axial damping elements configured to absorb a frontal shock to the dial;

FIG. 4 shows an embodiment of the invention, further comprising lateral damping elements arranged between the dial feet and the plate.

### DETAILED DESCRIPTION OF THE INVENTION

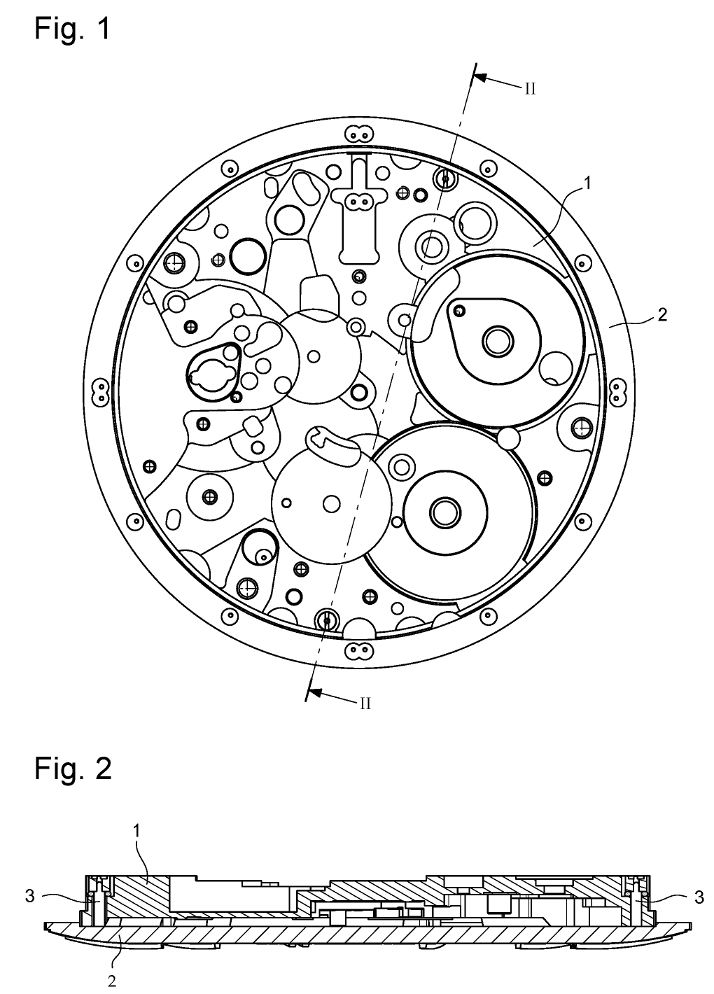

FIG. 1 is a plan view of the rear face of the watch plate 1 according to one embodiment of the invention. The watch dial 2 is attached to the front face of the plate. FIG. 2 shows a cross-section in the A-A plane shown in FIG. 1. The A-A plane in the cross-section runs through the central axes of the two dial feet 3.

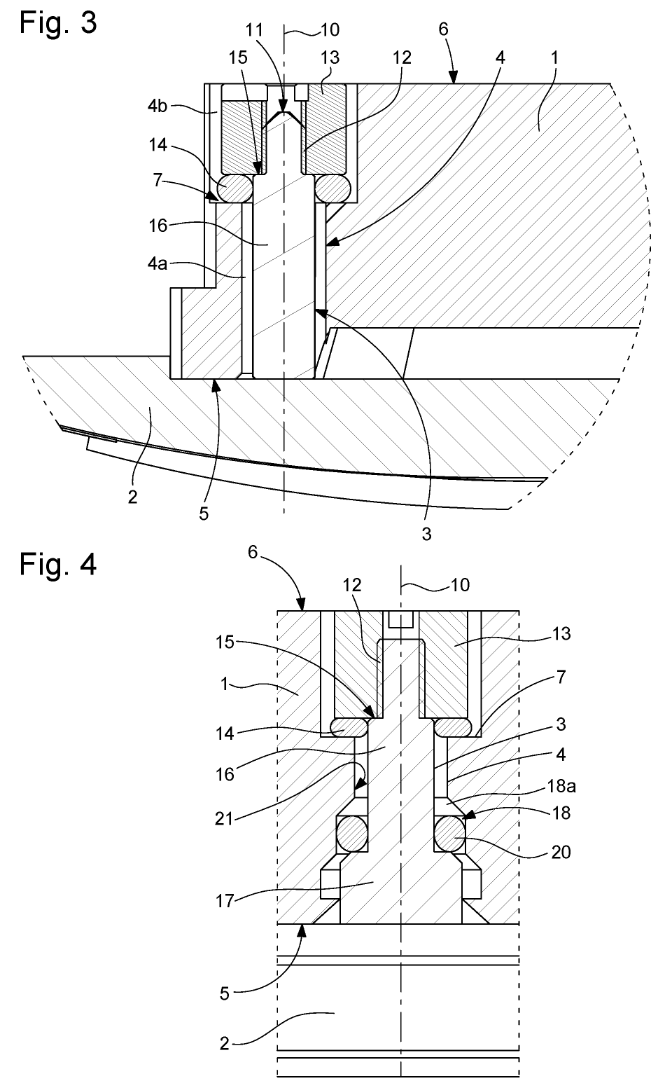

The way in which one of the feet 3 on the dial 2 is attached to the plate 1 is illustrated in detail in FIG. 3, the other foot being attached in the same way. The foot 3 is fastened to the rear face of the dial 2, for example by soldering, driving in or equivalent. The foot 3 is inserted into an orifice 4 that runs through the plate 1 from its front face 5 to its rear face 6. The through orifice 4 comprises a peripheral stop 7 arranged between a first portion 4a of the orifice that runs between the front face 5 of the plate 1 and the stop 7, and a second portion 4b that runs between the stop 7 and the rear face 6 of the plate 1. In cross-sectional planes perpendicular to the central axis 10 of the orifice 4, the cross-sectional area of the first portion 4a of the orifice is smaller than the cross-sectional area of the second portion 4b of the orifice. However, the stop 7 is visible and can be reached from the rear face 6 of the plate 1 when the orifice 4 is empty. FIG. 1 shows that the orifices 4 are near the outer rim of the plate 1, such that the second portion 4b of the orifices is partially open laterally, near said outer rim, while the first portion 4a is completely surrounded by the material of the plate. In other embodiments, the orifices 4 can be farther from the rim of the plate, such that the second portion 4b is also completely surrounded by the material of the plate 1.

FIG. 3 shows that the end 11 of the foot 3 of the dial 2 moves away from the stop 7 when the foot is inserted into the orifice 4 until the dial 2 fits into the front face 5 of the plate 1. The part of the foot 3 that extends beyond the orifice stop 7 is provided with an outer threading portion 12. A nut 13 with a tapping corresponding to the outer threading of the foot is screwed onto the foot. Between the nut 13 and the orifice stop 7, an axial damping element 14 is arranged in the form of an O ring made of a flexible material. The ring 14 is partially compressed between the nut 13 and the stop 7 on the orifice 4. Due to the resilience of the damping element 14, the attachment between the dial 2 and the plate 1 is less susceptible to the transfer of frontal shocks. This reduces the risk of the dial cracking as a result of such shocks.

For the purposes of this description, partial compression is defined as compression that keeps the damping element in a flexible state that allows frontal shocks to be absorbed while keeping the dial on the plate. The degree of compression depends on the dimensions of the assembly and the choice of material for the damping elements. One example of a material that can be used in the invention is Hytrel®7246 from the manufacturer Celanese. The following are examples of applicable but non- limiting dimensions for the O-ring 14 in embodiments of the invention: internal diameter between 0.5 and 0.7 mm. Ring diameter in cross-section (diameter of the “O”): approx. 0.3 mm. Both the feet 3 and the nuts 13 can be made of steel or any other equivalent material that enables the functionality described above.

In the embodiment shown, the foot 3 is also provided with a peripheral stop 15 arranged between the threading portion 12 of the foot and the rest of the foot, which consists of a cylindrical part 16. The nut 13 is screwed onto the foot 3 until said nut is secured against the foot stop 15. At this point, the nut 13 is in direct contact with the stop 15. The equivalent of direct contact could be achieved by adding a solid element between the nut 13 and the stop 15, for example a washer. For the purposes of this description, this type of contact is defined as indirect contact.

When the foot 3 is fully inserted into the orifice 4, the position of the foot stop 15 relative to the orifice stop 7 is designed so that the ring 14 is partially compressed between the fastened nut 13 and the orifice stop 7. This configuration ensures that the nut 13 can be screwed against the stop 15 by a predetermined fastening force necessary to ensure the attachment of the dial 2. At the same time, this force generates a predetermined compression of the O-ring 14. This configuration is advantageous because it enables a well-defined damping effect to be applied according to the resilience of the ring material.

The position of the feet 3 and of the orifices 4 determines the orientation of the dial 2 relative to the plate 1. Preferably, in the embodiment shown in FIG. 3, one of the orifices 4 is circular (seen in cross-section), and configured to receive one of the dial feet 3 with essentially no clearance between the cylindrical portion 16 of said foot and the wall 21 of the orifice, while the other orifice is oblong. This configuration allows the orientation of the dial to be adjusted slightly and ensures that the dial 2 is fastened to the plate 1 without introducing stresses that could damage the dial.

According to one embodiment, lateral damping is provided in addition to the axial damping described above. An example of such an embodiment is shown in FIG. 4.

FIG. 4 shows a cross-sectional view in a plane comprising the central axis 10 of one of the feet 3 on the dial 2. As in the previous form, the axial damping ring 14 is arranged between the nut 13 and the stop 7 on the orifice 4. Moreover, a second ring 20 is arranged between the cylindrical part 16 of the foot 3 and the inner wall 21 of the orifice 4. The ring 20 acts as a lateral damping element, capable of absorbing lateral shocks to the watch.

In the form shown, the foot 3 has a head 17 with a larger diameter than the part 16, the head 17 being attached to the dial 2. Moreover, the orifice 4 is provided with a radial bed 18 for holding the second O-ring 20 in this bed. The dimensions and position of the bed 18 are configured so that the ring 20 can be arranged in the bed 18 essentially without being compressed in the axial direction of the foot 3, while laterally, the ring 20 is partially compressed between the part 16 of the foot 3 and the wall 21 of the orifice 4. According to the embodiment shown in FIG. 4, the back 18a of the bed 18, seen from the front face 5 of the plate 1, is produced in a conical shape. This arrangement makes it easier to maintain the ring 20 in an axial direction between the back 18a of the bed 18 and the head 17 of the foot 3.

In the embodiment shown in FIG. 4, both orifices 4 are preferably circular (cross-sectional view). The lateral damping elements 20 will automatically centre the dial feet 3 without any risk of stress.

Certain characteristics of the embodiments described above do not limit the scope of the invention, which is defined solely by the appended claims. For example, instead of nuts 13, other fastening elements can also be used, such as rivets or fasteners attached to the feet 3 by setting or driving in.

It can be seen in the drawings that for each of the orifices 4, the orifice stop 7 is set back from the rear face 6 of the plate 1 and that the outer face of the nut 13 is flush with said rear face 6 when the nut 13 is fastened to the dial foot 3. This means that the position of the stop 7 and the dimensions of the nut 13 are chosen so that said positioning flush with the rear face 6 is achieved.

However, it is not beyond the scope of the invention to have nuts (or equivalent) with outer faces that are not flush with the rear face 6 of the plate. This may be the case, for example, when the distance between the stop 7 and the rear face 6 is less than the height of the nuts 13. In an extreme case, which is also within the scope of the invention, the orifice stop coincides with the rear face 6 of the plate, meaning that the nuts (or equivalent) are above the rear face 6 of the plate when the dial is attached.

Preferably there are two dial feet, but it is not beyond the scope of the invention to have more than two dial feet attached to the plate as described above or equivalent.

A watch according to the invention is produced by a manufacturing process that comprises a method for attaching the dial 2 to the plate 1 of the watch movement. A method for assembling the dial 2 and the plate 1 according to the embodiment shown in FIGS. 1-3 or equivalents thereof comprises the following steps:

position the plate 1, with the rear face 6 hidden, on a support surface, The surface is preferably horizontal,

then fit the dial 2 on the front face 5 of the plate, by inserting the dial feet 3 into the orifices 4 in the plate, thus obtaining a non-fixed assembly,

invert the non-fixed assembly on the support surface,

then, fit the axial damping elements on the dial feet. In FIGS. 1-3, the O-rings 14 are fitted around the feet 3 until the rings come into contact with the stops 7 on the orifices 4,

then, fasten the fastening elements to the ends of the feet until the axial damping elements are partially compressed. In FIGS. 1-3, the nuts 13 are screwed against the stops 15 on the dial feet. This action automatically applies a predetermined compression to the O-rings 14.

A preferred method for assembling the dial 1 and the plate according to the embodiment shown in FIG. 4 comprises the following steps:

position the plate, with the rear face hidden, on a support surface, preferably horizontal,

then, fit the lateral damping elements on the dial feet, In the example in FIG. 4, the O-rings 20 are fitted around the dial feet 3 until the rings come into contact with the heads 17 on the feet,

then fit the dial 2 on the front face 5 of the plate, by inserting the dial feet 3 into the orifices 4 in the plate, thus obtaining a non-fixed assembly,

invert the non-fixed assembly on the support surface,

then, fit the axial damping elements 14 on the dial feet,

fasten the fastening elements 13 to the ends of the feet until the axial damping elements are partially compressed.

1. A watch comprising a movement comprising a plate (1), the plate having a front face (5) and a rear face (6), and a dial (2) attached to the front face of said plate,
wherein the dial is attached to the plate by:
at least two feet (3) fastened to the dial, said feet being inserted into orifices (4) that run through the plate (1), each of the orifices (4) being provided with a peripheral stop (7), the feet being inserted such that the ends (11) of the feet extend away from said stop (7),
fastening elements (13) fitted respectively on the feet (3) on the side with said ends (11) of the feet, so as to attach the dial (2) to the plate (1),
axial damping elements (14) made of a flexible material, arranged between the fastening elements (13) and the peripheral stops (7) on the orifices (4) and partially compressed between said fastening elements (13) and said stops (7).

2. The watch according to claim 1, wherein:
each of the feet (3) is also provided with a peripheral stop (15),
the fastening elements (13) are in direct or indirect physical contact with the foot stops (15).

3. The watch according to claim 1, wherein the feet (3) on the dial (2) are provided with threaded portions (12) on the side with said ends (11), and wherein the fastening elements (13) are nuts screwed onto the threaded portions (12) of the feet.

4. The watch according to claim 1, wherein the axial damping elements are O-rings (14) arranged around the feet (3) on the dial (2).

5. The watch according to claim 1, wherein the peripheral stop (7) on the orifices (4) is set back from the rear face (6) of the plate (1).

6. The watch according to claim 5, wherein the fastening elements (13) have an outer face that is flush with the rear face (6) of the plate (1).

7. The watch according to claim 1, further comprising a plurality of lateral damping elements (20) arranged laterally between the dial feet (3) and the wall (21) of the orifices (4), the lateral damping elements being partially compressed between said feet (3) and said wall (21).

8. The watch according to claim 7, wherein the lateral damping elements are O-rings (20) arranged around the feet (3) on the dial (2).

9. The watch according to claim 7, wherein each of the orifices (4) is provided with a radial bed (18) configured to hold the lateral damping element (20) arranged around the foot (3) inserted in the orifice.

10. The watch according to claim 9, wherein each of the feet (3) comprises a head (17) with a large diameter relative to a cylindrical portion (16) of the foot, and wherein the lateral damping element (20) is arranged between the head (17) of the foot and the back (18a) of said bed (18).

11. The watch according to claim 10, wherein the back (18a) of said bed (18) is conical in shape.

12. The watch according to claim 7, wherein the orifices (4) have a circular cross-section in a plane perpendicular to the dial feet (3).

13. A method for assembling the dial (2) and the watch plate (1) according to claim 1, the method comprising the following steps:
position the plate (1), with the rear face (6) hidden, on a support surface,
then fit the dial (2) on the front face (5) of the plate, by inserting the dial feet (3) into the orifices (4) in the plate, thus obtaining a non-fixed assembly,
invert the non-fixed assembly on the support surface,
then, fit the axial damping elements (14) on the dial feet (3),
then, fasten the fastening elements (13) to the ends of the feet (3) until the axial damping elements (14) are partially compressed.

14. The method for assembling the dial and the watch plate according to claim 7, the method comprising the following steps:
position the plate (1), with the rear face (6) hidden, on a support surface,
fit the lateral damping elements (20) on the dial feet (3),
then fit the dial (2) on the front face (5) of the plate, by inserting the dial feet (3) into the orifices (4) in the plate, thus obtaining a non-fixed assembly,
invert the non-fixed assembly on the support surface,
then, fit the axial damping elements (14) on the dial feet (3),
then, fasten the fastening elements (13) to the ends of the feet (3) until the axial damping elements (14) are partially compressed.
